(19) United States
(12) Patent Application Publication
(10) Pub. No.: US 2007/0275842 A1
(43) Pub. Date: Nov. 29, 2007

(54) Sheet folding device and sheet post-processing apparatus

(75) Inventors: Hitoshi Tamura, Tokyo (JP); Masaaki Uchiyama, Tokyo (JP); Mikihiro Yamakawa, Tokorozawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/716,626

(22) Filed: Mar. 12, 2007

(30) Foreign Application Priority Data
May 24, 2006 (JP) 2006-143698

(51) Int. Cl. B31F 1/00

(52) U.S. Cl. 493/419

(57) ABSTRACT

A sheet holding apparatus having: first and second folding rollers; and first and second pressurizing rollers, wherein the apparatus introduces a sheet of paper by rotating at least the first folding roller to pass the sheet of paper between the first folding roller and the first pressurizing roller, while the two folding rollers are separated when the first pressurizing roller pressurizes the first folding roller; and folds the paper by creasing between the two folding rollers by rotating the two folding rollers in opposite directions when the pressurizing rollers respectively pressurize the two folding rollers, and by conveying the sheets of paper while holding them by the two folding rollers, wherein when folding, the two folding rollers are pressurized to each other, and a driving force is transferred from the first to the second folding roller, and the two folding rollers are rotated in the opposite directions.

### CROSS REFERENCE TO RELATED APPLICATION

The present application is based on Japanese Patent Application No. 2006-143698 filed with Japan Patent Office on May 24, 2006, the entire content of which is hereby incorporated by reference.

### BACKGROUND OF THE INVENTION

1. Field of the Invention

The present invention relates to a sheet folding device suitable for using as an auxiliary device of an image forming apparatus and a sheet post-processing apparatus.

2. Description of the Related Art

As a sheet folding device used as an auxiliary device of an image forming apparatus, for example, as described in Unexamined Japanese Utility Model Application Publication No. 62-96067(Hereinafter we refer to Patent Document 1), there is a folding device for using a pair of folding rollers, driving the folding rollers to rotate in the opposite directions, conveying a sheet of paper by one and the other of the folding rollers, folding the sheet of paper between both folding rollers, passing it through a nip between both folding rollers, thereby conveying it with creating a holding line.

In an apparatus described in Patent Document 1, folding motors as a driving source are connected respectively to a first folding roller and a second folding roller and by driving by the folding motors, the folding rollers are driven to rotate in the opposite directions.

In Unexamined Japanese Patent Application Publication 2005-96990(Hereinafter we refer to Patent Document 2), disclosed is a sheet folding device for driving the first and second folding rollers to rotate in the opposite directions by a power transfer mechanism having a switching mechanism for transferring or canceling the transfer from one driving source, thereby folding a sheet of paper.

In an apparatus described in Patent Documents 1, the first folding roller and the second folding roller are respectively driven by the driving sources, thereby are rotated in the opposite directions thus sheets of paper are folded. In such a folding device, caused by a time lag between start timings of driving motors the start timing of the first folding roller may be varied from the start timing of the second folding roller.

Further, in an apparatus described in Patent Document 2, although one driving source is used, when switching the first folding roller and second folding roller from the separation state to the pressurized state, in cases where the gear meshing condition of the driving system of each roller is bad, and when the mutual crests collide with each other, one of the gear rotates slightly, thus an appropriate meshing condition is obtained. Due to the slight rotation, a time lag between the start timings of the two folding rollers may be caused.

When the first and second folding rollers are varied in the start timing, a side of the sheet in contact with the roller at early start timing is sent into the nip portion between the rollers earlier than the side in contact with the roller at later start timing. Therefore, the fold line is shifted for example from the predetermined position T1 to T2 as shown in FIG. 1.

The shift of the folding position as shown in FIG. 1 reaches about 1 mm and when folded sheets of paper are bundled, the spine of the paper bundle becomes uneven, thus the quality of the processed article is deteriorated.

### SUMMARY OF THE INVENTION

A sheet holding apparatus reflecting one aspect of the present invention has a first folding roller, a second folding roller, and a first pressurizing roller; and a second pressurizing roller. The sheet folding apparatus executes an introducing step to introduce a sheet of paper by driving to rotate at least the first folding roller to pass the sheet of paper between the first folding roller and the first pressurizing roller, while the first folding roller and second folding roller are separated in a state where at least the first pressurizing roller pressurizes the first folding roller; and executes a folding step for folding the sheet of paper by creasing the sheets of paper between the first and second folding rollers by rotating the first folding roller and the second folding roller in opposite directions in a state where the first and second pressurizing rollers respectively pressurize the first and second folding rollers, and by conveying the sheets of paper while holding them by the first folding roller and second folding roller. In the folding step, the first folding roller and second folding roller are pressurized to each other, and by pressurizing of the first and second folding rollers a driving force is transferred from the first folding roller to the second folding roller, and the first and second folding rollers are rotated mutually in the opposite directions.

### BRIEF DESCRIPTION OF THE DRAWING

These and other objects, advantages and features of the invention will become apparent from the following description thereof taken in conjunction with the accompanying drawings in which:

FIG. 1 is a drawing for explaining a shift of the folding position;

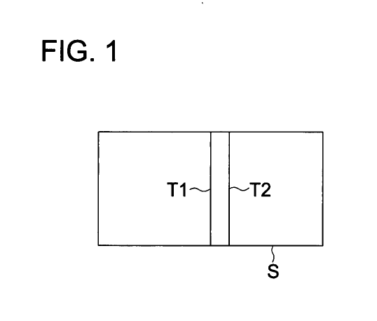

FIGS. 2(a) and (b) are drawings showing the sheet folding device relating to the embodiment of the present invention;

FIG. 3 is a drawing showing the drive mechanism at the step of conveying a sheet of paper S;

FIG. 4 is a drawing showing the drive mechanism at the step of folding the sheet of paper S;

FIG. 5 is a drawing showing the mechanism for moving the second folding roller;

FIG. 6 is a drawing showing the power transfer mechanism between the gears; and

FIG. 7 is a schematic view of the image forming apparatus having the sheet post-processing apparatus relating to the embodiment of the present invention.

### DETAILED DESCRIPTION OF THE PREFERRED EMBODIMENT

Hereinafter, the present invention will be explained by referring to the embodiment, though the present invention is not limited to the embodiment.

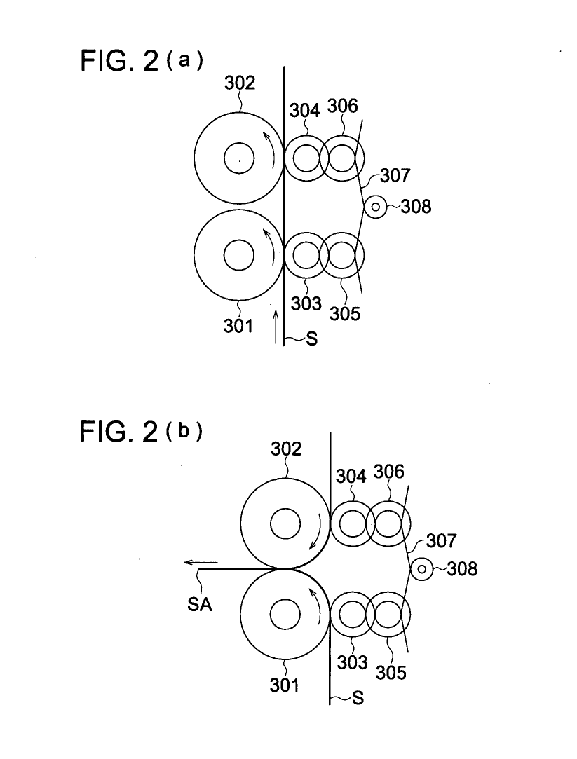

FIGS. 2(a) and 2(b) are drawings to explain a folding operation of the sheet folding device relating to the embodiment of the present invention.

FIG. 2(a) shows the step for introducing the sheet of paper S to the sheet folding device and FIG. 2(b) shows the folding step of the sheet of paper S.

Opposite to a folding roller 301 as a first folding roller, a folding roller 302 as a second folding roller is arranged, and a pressurizing roller 303 is pressurized to the folding roller 301, and a pressurizing roller 304 is pressurized to the folding roller 302. The pressurizing forces of the pressurizing rollers 303 and 304 are respectively given by a spring 370 via rollers 305 and 306. The spring 307 is fit to a fixed pin 308 at its center and compresses the shafts of the rollers 305 and 306, thus the pressurizing rollers 303 and 304 are respectively pressurized to the folding rollers 301 and 302.

As explained later, at the introduction step shown in FIG. 2(a), the folding roller 302 is away from the folding roller 301 and is driven to rotate in the same direction as the folding roller 301 as shown by the arrow.

Therefore, in the step of FIG. 2(a), the sheet of paper S introduced from underneath is conveyed upward by being held between the folding roller 301 and the pressurizing roller 303 and being held between the folding roller 302 and the pressurizing roller 304.

At the stage of conveying of the sheet of paper S with a predetermined length (for example, ½ or ⅓ of the length of the sheet of paper), the introducing step of the sheet of paper S is finished.

Next, the process goes to the folding step and as shown in FIG. 2(b), the folding roller 302 is pressurized to the folding roller 301. Further, at the folding step, the pressurizing rollers 303 and 304 are respectively kept in the pressurized state with the folding rollers 301 and 302.

At the folding step, the folding roller 302 is pressurized to the folding roller 301 and the driving of the folding roller 302 is shut off. Therefore, to the folding roller 302, the rotation driving force is transferred by contact with the folding roller 301 and the folding roller 302 is rotated.

In this way, the folding roller 301 and folding roller 302 are rotated mutually in the opposite directions, and midway between the folding roller 301 and the folding roller 302, the sheet of paper S is bent and enters the nip portion formed by the folding roller 301 and folding roller 302 with the fold line SA at the head.

The folding rollers 301 and 302 are rotated further, thus as shown in FIG. 2(b), the sheet of paper S is conveyed with the fold line SA at the head and folded.

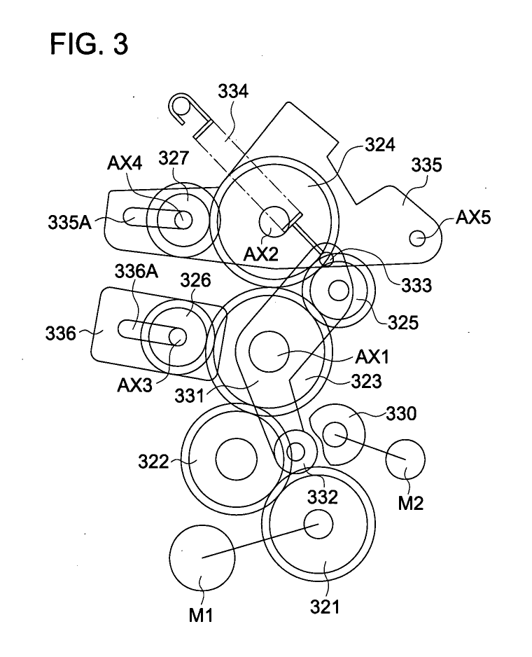

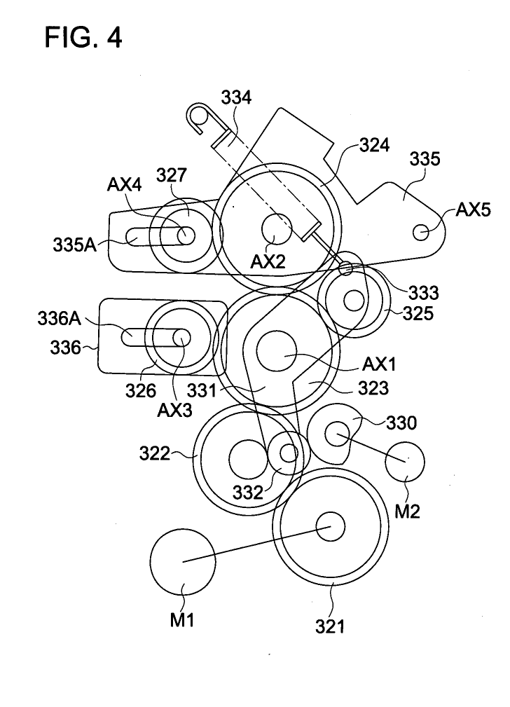

FIGS. 3 and 4 show the driving mechanism including the power transfer system of the sheet folding device shown in FIGS. 2(a)and 2(b), and FIG. 3 shows the driving mechanism at the step of conveying the sheet of paper S, and FIG. 4 shows the driving mechanism at the step of folding the sheet of paper S.

The rotations of the folding rollers 301 and 302 shown in FIGS. 2(a) and 2(b) by the arrow are driven by a motor Ml.

To a shaft AX1, the folding roller 301 and a gear 323 are fixed, and to a shaft AX2, the folding roller 302 and a gear 324 are fixed, and to a shaft AX3, the pressurizing roller 303 and a gear 326 are fixed, and to a shaft AX4, the pressurizing roller 304 and a gear 327 are fixed.

Driving to move the folding roller 302 from the position shown in FIG. 2(a) to the position shown in FIG. 2(b) and switching of the rotation driving of the folding roller 302 are executed by a motor M2.

A cam 330 is rotated by the motor M2, and a cam follower 332 is moved by the rotation of the cam 330, and a lever 331 is rotated around the shaft AX1.

By the rotation of the lever 331, a gear 325 born by the lever 331 is moved and meshed with the gear 324.

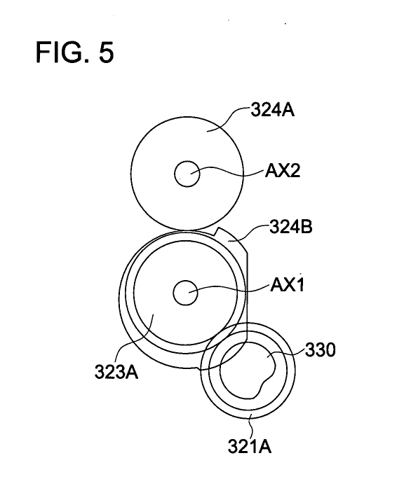

Further, by the rotation of the motor M2, the folding roller 302 is separated from the folding roller 301. The mechanism for moving the folding roller 302 like this is shown in FIG. 5. To the shaft to which the cam 330 is fixed, a gear 321A is fixed and a gear 323A rotatably born by the shaft AX1 is meshed with the gear 321A. A cam 323B rotating integrally with the gear 323A born by the shaft AX1 makes contact with a circular cam follower 324A born by the shaft AX2 by which the folding roller 302 is born, and the contact is ensured surely by the weight of a lever 335 born by a shaft AX5, the folding roller 302, and gears 324 and 324A.

On the lever 335, the folding roller 302 is born by the shaft AX2 and the pressurizing roller 327 is born by the shaft AX4. Further, the shaft AX4 is supported by an oblong hole 335A formed in the lever 335 and can be moved and as explained above, the pressurizing roller 304 is pressurized to the folding roller 302 by the spring 307.

The pressurizing roller 303 and shaft AX3 of the gear 326 are guided by an oblong hole 336A formed in a fixing support plate 336 and can be moved and by the spring 307, the pressurizing roller 303 is pressurized to the folding roller 301.

A spring 334 presses the lever 331 so as to rotate counterclockwise as shown in FIGS. 3 and 4 and makes the cam follower 332 touch with the cam 330.

The outside diameter of the gear 323 and the outside diameter of the folding roller 301 are almost the same and the outside diameter of the gear 324 and the outside diameter of the folding roller 302 are almost the same. Therefore, at the sheet folding step, when the folding roller 302 is pressurized to the folding roller 301, as shown in FIG. 4, the teeth of the gear 323 and the teeth of the gear 324 are overlaid on each other viewed in the shaft direction.

Even if the teeth of the gear 323 and the teeth of the gear 324 are overlaid on each other, the power is not transferred from the gear 323 to the gear 324.

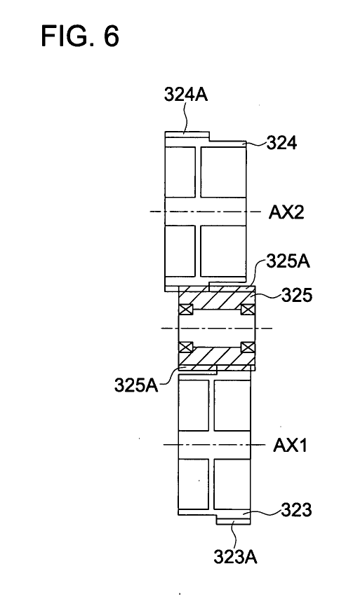

Such a power transfer mechanism to the gear 323 and gear 324 will be explained by referring to FIG. 6.

In FIG. 6, teeth 323A of the gear 323 and teeth 324A of the gear 324 are installed at shifted positions in the directions of the shafts AX1 and AX2. Therefore, even if the gear 323 and gear 324 are installed so that the teeth 323A and 324A are overlaid on each other viewed in the directions of the shafts AX1 and AX2, the power of the gear 323 is not transferred to the gear 324. On the other hand, teeth 325A of the gear 325 are formed in a length of meshing with the teeth 323A and 324A, so that when the gear 325 approaches the gears 323 and 324, the power of the gear 323 is transferred to the gear 324 via the gear 325.

At the step of introducing sheets of paper into the folding device, as shown in FIG. 3, the small diameter portion of the cam 330 is opposite to the cam follower 332. As a result, the lever 331 is at the position rotated counterclockwise by the spring 334 and the power of the gear 323 is transferred to the gear 324 via the gear 325. Further, the folding roller 302 is pushed up by the cam 323B and is separated from the folding roller 301.

By doing this, the folding roller 301 and folding roller 302, as shown in FIG. 2(a), are rotated in the same direction, thereby convey the sheet of paper S, and introduce it into the folding device.

At the folding step of the sheets of paper S, the cam 330 rotates and the large diameter portion presses the cam follower 332. By doing this, the lever 331 rotates clockwise and separates the gear 325 from the gear 324, and the cam 323B rotates to the phase position where the folding roller 302 is moved down, thus the folding roller 302 makes contact with the folding roller 301. And, the folding roller 302, by the contact with the folding roller 301, rotates by following the folding roller 301.

As explained above, the folding roller 302, at the step of introducing the sheets of paper S into the folding device, is separated from the folding roller 301, is driven by the motor M1, and rotates in the same direction as that of the folding roller 301, and at the step of folding the sheets of paper S, the folding roller 302 makes contact with the folding roller 301, is separated from the power transfer system, so that rotates by following the folding roller 301.

Therefore, the start timing of the folding step, that is, the reverse start timing in the rotational direction of the folding roller 302 is set precisely and the fold line of each sheet of paper is formed at the precise position.

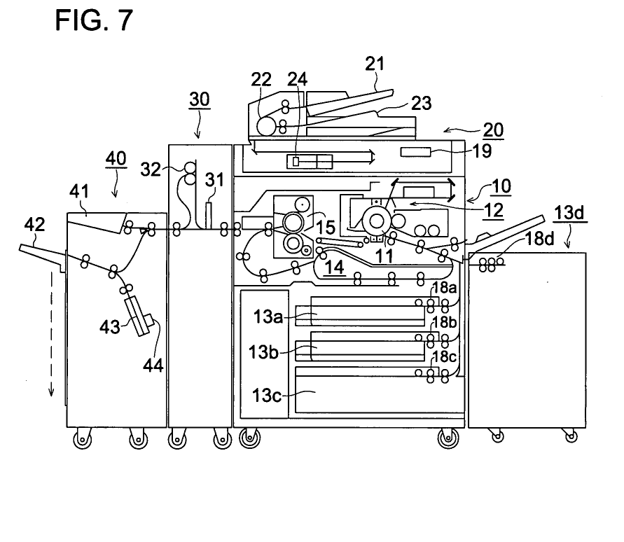

FIG. 7 is a schematic view of the image forming apparatus having the sheet post-processing apparatus relating to the embodiment of the present invention.

In FIG. 7, numeral 10 indicates an image forming unit for forming an image on a sheet of paper by the electrophotographic method, numeral 20 indicates an image reading unit for reading an image of a document and outputting image data, numeral 30 indicates a sheet post-processing apparatus having a perforating device 31 and a sheet folding device 32, and numeral 40 indicates a sheet post-processing apparatus having a binding device 44.

The image forming unit 10 includes a photoreceptor 11, an image forming unit 12 for charging, exposing the photoreceptor 11, and developing to form a toner image, and transferring the toner image formed on the photoreceptor 11 onto a sheet of paper, storage units 13a, 13b, 13c, and 13d for distinguishing and storing sheets of paper of various sizes for each size, paper feed units 18a, 18b, 18c, and 18d having rollers for taking out sheets of paper one by one from the storage units 13a, 13b, 13c, and 13d and conveying them to the image forming unit 12, a reverse paper feed unit 14, when forming an image on both sides of each sheet of paper, for inverting the sheet of paper and conveying the sheet of paper with one side recorded to the image forming unit 12, and a fixing device 15 for fixing the toner image transferred onto the sheet of paper.

The image reading unit 20 includes a document feed table 21 on which documents are loaded, a platen roller 22 for conveying documents and forming a reading position, a document ejection table 23 on which a read document is loaded, and an image sensor 24 for receiving image light reflected from a document and generating a reading signal.

The sheet post-processing apparatus 30 includes the perforating device 31 for making a hole for a file and the sheet folding device 32 explained previously.

A sheet post-processing apparatus 40 connected to the sheet post-processing apparatus 30 includes a fixed paper receiving tray 41 for receiving sheets of paper when forming few images, an elevating paper receiving tray 42 for receiving sheets of paper when forming a large amount of images and in the binding mode, an intermediate stacker 43 for stacking sheets of paper, and a stapler 44 for binding a corner or one side of a sheet of paper.

According to the present invention, at the step of folding sheets of paper, the second folding roller is pressured to the first folding roller, and the driving force is transferred by pressurizing from the first folding roller to the second folding roller, thus both folding rollers are rotated mutually in the opposite directions, so that the timing of sending sheets of paper to the nip portion between both folding rollers is not varied, and shifts of the folding position due to the time lag can be eliminated.

What is claimed is:

1. A sheet folding apparatus comprising:
a first folding roller;
a second folding roller;
a first pressurizing roller; and
a second pressurizing roller, wherein the sheet folding apparatus executes an introducing step to introduce a sheet of paper by driving to rotate at least the first folding roller to pass the sheet of paper between the first folding roller and the first pressurizing roller, while the first folding roller and second folding roller are separated in a state where at least the first pressurizing roller pressurizes the first folding roller; and executes a folding step for folding the sheet of paper by creasing the sheets of paper between the first and second folding rollers by rotating the first folding roller and the second folding roller in opposite directions in a state where the first and second pressurizing rollers respectively pressurize the first and second folding rollers, and by conveying the sheets of paper while holding them by the first folding roller and second folding roller,
wherein in the folding step, the first folding roller and second folding roller are pressurized to each other, and by pressurizing of the first and second folding rollers a driving force is transferred from the first folding roller to the second folding roller, and the first and second folding rollers are rotated mutually in the opposite directions.

2. The sheet folding apparatus of claim 1, further comprising a power transfer mechanism for rotating the second folding roller in the same direction as the first folding roller in the introducing step of the sheet of paper.

3. The sheet folding apparatus of claim 2, wherein the power transfer mechanism transfers the driving force for rotating the first folding roller onto the second folding roller in the introducing step of the sheet of paper, and separates the second folding roller from a driving system to drive the first folding roller in the folding step of the sheet of paper.

4. The sheet folding apparatus of claim 3, wherein the power transfer mechanism comprises:
a first gear fixed on a rotation axis of the first folding roller;
a second gear fixed on a rotation axis of the second folding roller; and
a third gear to transfer a driving force of the first gear onto the second gear,
wherein transfer and transfer release of the driving force between the first and second folding rollers are conducted by displacement of the third gear.

5. The sheet folding apparatus of claim 4, wherein the second gear is arranged at a position separated in a direction of the rotation axis from the first gear so that the driving force of the first folding roller is not transferred to the second folding roller in the folding step of the sheet of paper.

6. A sheet post-processing apparatus, comprising the sheet folding apparatus described in claim 1.
